(19) United States
(12) Patent Application Publication
(10) Pub. No.: US 2025/0307690 A1
(43) Pub. Date: Oct. 2, 2025

(54) METHOD AND SYSTEM FOR MACHINE-LEARNING DATASET GENERATION FROM MIXED-MEDIA DATABASES

(71) Applicant: Global Publishing Interactive, Inc., Troy, OH (US)

(72) Inventors: Robert Hoffer, Miami Beach, FL (US); Cosmo Kay, Sunnyvale, CA (US)

(21) Appl. No.: 18/617,605

(22) Filed: Mar. 26, 2024

(51) Int. Cl. G06N 20/00

(52) U.S. Cl. CPC G06N 20/00

(57) ABSTRACT

A media generator may generate media based on a canon associated with a media asset in a style of the media asset. The media generator may receive an identification of a media asset representing a set of related media. The media generator may generate a training dataset based on the identification of the media asset. The training dataset may include a subset of the set of related media. The media generator may train a machine-learning model using the training dataset. The machine-learning model may be configured to generate media associated with the media asset. The media generator may then receive a request to generate media representing the media asset. The media generator may generate media by executing the machine-learning model based on the request. The media generator may facilitate a presentation of at least a portion of the media.

### TECHNICAL FIELD

This disclosure relates generally to machine-learning models for generating disparate datasets, and more particularly to machine-learning models for generating various types of media based on mixed-media databases.

### BACKGROUND

Graphical media such as comic books or graphic novels include a sequence of frames (e.g., pages, etc.) that include one or more panels that each depict portions of a story with graphics and/or text. Graphical media is often generated in parts, in collections, as a continuation of previous graphical media or related graphical media, etc. For example, a series of graphical media may be generated about a superhero. The series of graphical media may be developed based on other graphical media about a superhero team that the superhero was member of. Subsequent graphical media may be generated to include consistent details that do not conflict with previous graphical media. For example, media about a superhero may include particular recognizable colors for the superhero's costume or include the particular themes, etc. Thus, each subsequent graphical media that is generated may be more likely to introduce errors into the set of graphical media.

### SUMMARY

Methods are described herein for generating media based on mixed-media datasets. The methods may include receiving an identification of one or more media assets, wherein each media asset of the one or more media assets represents a set of related media; generating a training dataset based on the identification of one or more media assets, wherein the training dataset includes a subset of the set of related media of each media asset of the one or more media assets; training a machine-learning model using the training dataset, the machine-learning model being configured to generate content associated with a particular media asset; receiving a request to generate media representing the particular media asset, wherein the request includes an identification of a media asset and a media type; executing the machine-learning model using a feature vector derived at least in part from the identification of the media asset and the media type, wherein the machine-learning model generates media associated with the media asset and of the media type; and facilitating a presentation of at least a portion of the media.

The systems described herein for generating media based on mixed-media datasets. The systems may include one or more processors and a non-transitory computer-readable medium storing instructions that, when executed by the one or more processors, cause the one or more processors to perform any of the methods as previously described.

The non-transitory computer-readable media described herein may store instructions which, when executed by one or more processors, cause the one or more processors to perform any of the methods as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 illustrates a block diagram of an example media generation system that facilitates generation of media based on mixed-media datasets according to aspects of the present disclosure.

FIG. 2 illustrates a block diagram of an example process of generating media based on mixed-media datasets for according to aspects of the present disclosure.

FIG. 3 illustrates a block diagram of an example media generation system configured to generate media based on mixed-media datasets according to aspects of the present disclosure.

FIG. 4 illustrates a block diagram of an example distributed media generation system configured to generated media based on mixed-media datasets according to aspects of the present disclosure.

FIG. 5 illustrates a flowchart of an example process for generating media based on mixed-media datasets according to aspects of the present disclosure.

FIG. 6 illustrates an example computing device architecture of an example computing device that can implement the various techniques described herein according to aspects of the present disclosure.

### DETAILED DESCRIPTION

Methods and systems are described herein for generating media from mixed-media datasets. Mixed-media datasets may include different types of media that are related based on one or more characteristics and configured to be updated over time to include additional related media. The media may include contextual details associated with the content of the media. In some instances, new, artificial media may be generated based on the mixed-media datasets using one or more machine-learning models and/or procedural algorithms. The new, artificial media may include ancillary media, media associated with the contextual details of the mixed-media datasets, media associated with the one or more characteristics, etc. In addition, new, manually-generated media may also be added to the mixed-media datasets (e.g., adding to or modifying the contextual details of the mixed-media datasets, etc.) by one or more users associated with the mixed-media dataset. The machine-learning models and/or procedural algorithms may be used to perform data security (e.g., ensure new, artificial media and/or new manually-generated media are consistent with the mixed-media dataset) and retrained to improve subsequent media generation.

The media generation system may include a data controller and a media generator. The data controller may define mixed-media datasets that including media sharing one or more contextual details and/or characteristics, generate training datasets (e.g., the mixed-media dataset or derived from the mixed-media dataset), train machine-learning models to extract contextual details from various types of media, enforce data security (e.g., write protection, etc.) by authenticating new media using the mixed-media dataset, etc. The media generator may use one or more machine-learning models and/or procedural algorithms trained using the training dataset to automatically generated media that conforms to the mixed-media dataset. The new, artificial media may of any media type (e.g., text, audio segments, images, video segments, interactive media (e.g., video games, web-based media, etc.), webpages, interactive content, combinations thereof, or the like). The media generation system may use the data controller to authenticate the new, artificial media (e.g., by ensuring the new, artificial media complies with the mixed-media dataset, etc.) before outputting the new, artificial media via one or more communication channels. Authenticating the new, artificial media ensure the new, artificial media does not include hallucinations or contextual details that may conflict with or deviate from the mixed-media dataset.

Mixed-media datasets may include a curated set of media such as one or more of images, alphanumeric text, audio segments, video, interactive media (e.g., video games, etc.), combinations thereof, or the like, that share common one or more contextual details or one or more characteristics. For example, the common contextual detail or characteristics may correspond to a character and the mixed-media dataset may include images depicting the character, text including information associated with the character, a video including the character, etc. The media of the mixed-media dataset may include direct media (e.g., where the character is featured) and indirect media (e.g., where the character is included, but not necessarily the focus of the indirect media). The mixed-media dataset may be augmented by deriving a set of contextual details from the media of the mixed-media dataset representing a canon of the common one or more contextual details or one or more characteristics. Returning to the previous example, the mixed-media dataset may represent a canon of the character including a set of contextual details related to the character (e.g., such as, but not limited to, plot and/or subplots information, representations of an appearance of the character, information associated with an appearance of the character, information associated with a wardrobe such as particular apparel and color schemes, biographical information, demographic information, settings, audio samples of the character, video samples of the character, symbols associated with the character, themes associated with the character, tones associated with the character, an identification of associated characters, information associated with the associated characters, etc.).

The data controller may include one or more machine-learning models and/or other algorithms configured to analyze mixed-media datasets to identify contextual details of a mixed-media dataset. The data controller may also analyze new media to be added to the mixed-media dataset to identify contextual details of the new media. The data controller may then compare the contextual details of the new media to the contextual details of the mixed-media dataset to determine the contextual details of the new media contradict or conflict with the contextual details of the mixed-media dataset. For example, a mixed-media dataset may include a representation of an origin of a character (e.g., such as an indication of where the character is from, events that impacted the character, etc.). The new media may be analyzed to determine whether the new media includes contextual details associated with the character that conflict with the origin of the character (e.g., indication that the character is from a different place, representation of alternate events, etc.).

If the data controller determines that the contextual details of the new media comply with the mixed-media dataset (e.g., do not contradict the contextual details of the mixed-media dataset or deviate from with the contextual details of the mixed-media dataset, etc.), the data controller may store the new media in the mixed-media dataset or link the new media to the mixed-media dataset. The data controller may also update the contextual details of the mixed-media dataset (e.g., stored as metadata or other data within the mixed-media dataset) to include the contextual details of the new media.

If the data controller determines that the contextual details of the new media do not comply with the mixed-media dataset, then the data controller may cause the machine-learning models and/or procedural algorithms of the media generator to execute training iteration using the output from the input feature vector that generated the new media, the output from the data controller, the mixed-media dataset, user input, combinations thereof, or the like. The training iteration may update the machine-learning model and/or procedural algorithms to increase a likelihood that subsequently generated new media will comply with the mixed-media dataset. The media generator may then generate new versions of the new media.

In some examples, the data controller may facilitate write protection by preventing new media and/or contextual details that conflict with the mixed-media dataset from being used to update the mixed-media dataset. In other examples, if the data controller detects conflicting contextual details, the data controller may request user input requesting authorization to add the new media to the mixed-media dataset. The user input may indicate an acceptance of the contradiction or conflict, the user input may indicate that the new media is to replace media of the mixed-media dataset that conflict (e.g., replace the images, video, etc. of the mixed-media dataset from which the contradicting or conflicting contextual details are identified with the new media). In still yet other examples, if the data controller detects conflicting contextual details, the data controller may store only the non-conflicting contextual details of the new media in the mixed-media dataset.

The data controller may include one or more machine-learning models trained to identify contextual details within various types of media. The one or more machine-learning models may be stored in a server (e.g., for remote processing of the mixed-media datasets), within local memory (e.g., accessible to the data controller), within memory of a user device (e.g., computing device, mobile device such a smartphone or tablet, etc.), combinations thereof, or the like. The one or more machine-learning models may include machine-learning models configured to analyze different types of media. For example, a first machine-learning model may be configured to analyze images and/or video, a second machine-learning model may be configured to analyze audio and/or text, etc. The first machine-learning model may be trained to perform edge detection (e.g., to detect panels within a frame of a comic book, characters, settings, objects, symbols, etc.), image segmentation (e.g., detect different components within a frame such as background, foreground, characters, objects, text bubbles, onomatopoeia or other text within the image, etc.), classifiers (e.g., to distinguish the different components detected, etc.), sematic or contextual analysis (e.g., determine a meaning or context associated with a panel), and/or the like. The first machine-learning model may be, but is not limited to, neural networks (e.g., such as recurrent neural networks, mask recurrent neural networks, convolutional neural networks, faster convolutional neural networks, etc.), you only look once (YOLO), EfficientDet, deep learning networks, combinations thereof, or the like.

The second machine-learning model may be trained to identify text such as text within an image, etc. such as, but not limited to, speech bubbles or other dialog, narration or stage direction, onomatopoeia, etc. and determine semantic and/or contextual information from the identified text (e.g., such the meaning of the text, an overall sentiment or mood of the panel, topic, actions performed by characters, etc.). The second machine-learning models may be, but is not limited to, transformers (generative pre-trained transformers (GPT), Bidirectional Encoder Representations from Transformers (BERTs), text-to-text-transfer-transformer (T5), or the like), deep learning networks, generative adversarial networks (GANs), convolutional neural networks, recurrent neural networks (e.g., long short-term memory (LSTM), etc.), recurrent gated units (GRUs), combinations thereof, or the like. In some examples, a single machine-learning model (e.g., such as a large-language model, ensemble models, etc.) may be trained to perform the operations of the first machine-learning model, the second machine-learning model, etc.

The one or more machine-learning models may be trained using supervised learning, unsupervised learning, semi-supervised learning, transfer learning, reinforcement learning, combinations thereof, or the like. One or more training datasets may be defined based on the machine-learning model being trained, an output expected from the machine-learning model, a selected training methodology, one or more accuracy thresholds, combinations thereof, or the like. For instance, training datasets for a machine-learning models configured to extract contextual details from graphical media (e.g., images and/or video, etc.), may include a set of graphical media. The training dataset may be augmented with labels for supervised learning, semi-supervised learning, etc.

The type of graphical media included in the training dataset and the quantity of data included in a training dataset may be determined by the one or more accuracy thresholds. The closer the training data is to the input from that will be passed to the machine-learning model after training, the more accurate the trained machine-learning model will be for those inputs. For example, a machine-learning model that is to be trained to identify contextual details associated with superheroes may be more accurate if trained using a training dataset including mixed-media associated superheroes. In some examples, the training data may include the mixed-media dataset. The training data may include additional data (e.g., historical data, manually generated data, procedurally generated data, etc.) and/or augmented data (e.g., such as labels, metadata, etc.). In other examples, the training data may data other than the mixed-media dataset or a portion of the mixed media-dataset.

In addition, a larger training dataset may correlate with a higher accuracy evaluation of the trained machine-learning model. The one or more accuracy thresholds may be used to determine the data types included in the training dataset and/or the size of the training datasets. The one or more accuracy thresholds may be predetermined (e.g., a minimum accuracy threshold), defined from user input (e.g., a desired accuracy threshold), or dynamically (e.g., based on execution of the machine-learning model, labels, training iterations, feedback a user or other module, combinations thereof, or the like). The one or more machine-learning models may be trained for a predetermined time interval, predetermined quantity of iterations, and/or until the one or more accuracy metrics are reached (e.g., such as, but not limited to, accuracy, precision, area under the curve, logarithmic loss, F1 score, mean absolute error, mean square error, or the like).

Once trained the one or more machine-learning models may receive an input media segment (e.g., a portion of new media, the entire new media, a representation of the new media, or the like). The input media segment be represented as a feature vector (e.g., a set of features organized according to one or more domains such as, but not limited to, time). The one or more machine-learning models may output an indication of whether the new media segment includes contextual details that are consistent with the mixed-media dataset (e.g., do not contradict and/or have a degree of deviation that less than a threshold, etc.). The one or more machine-learning models may output a binary value (e.g., indicating whether the new media segment complies with the mixed-media dataset or does not comply with the mixed-media dataset, etc.), a degree of deviation between the new media segment and the mixed-media dataset, a confidence value, an estimated accuracy of the output (e.g., a degree in which an output of a machine-learning model conforms to the training data or internal weights of the machine-learning model, etc.), an identification of one or more contextual details of the new media that do not comply with the mixed-media dataset, an identification of one or more contextual details of the mixed-media dataset that conflict with the contextual details of the new media, combinations thereof, or the like.

The media generator may include one or more machine-learning models configured to generate one or more types of media that are based on the mixed-media dataset such as, but not limited to, text, images, video segments (e.g., such as, but not limited to, a trailer associated with the mixed-media dataset or media of the mixed-media dataset, a teaser for media associated with the mixed-media dataset, a movie, a looping video, a music video, an advertisement, a cutscene, such as for a video game associated with the mixed-media dataset, a dynamic typography video, a video configured for a social media platform (e.g., such as resolution, length, frame rate, etc.), an animation (e.g., such as a graphics interchange format, animated portable network graphics, etc.), combinations thereof, and/or the like), interactive media (e.g., video games, web-based media, etc.), webpages and/or documents therefor (e.g., such as, but not limited to, blog posts, encyclopedia entries, entries for an online publication, entries for crowdsourced and/or community-edited publications, instructions such as hypertext markup language or JavaScript, etc.), collateral (e.g., marketing collateral such as promotional media for the mixed-media dataset, media associated with or included in the mixed-media dataset, and/or the like), audio segments, combinations thereof, or the like. In some examples, the media generator may be configured to generate media that supports the media of the mixed-media dataset such as, but not limited to, character biographies; character summaries; plot summaries; information associated with symbols, symbolism, themes, tone, etc. present in the media of the mixed-media dataset; contextual details of the media; advertisements for the media of the mixed-media datasets; webpages such as, but not limited to, wiki webpages, sales or advertisement webpages, descriptive webpages, interactive webpages where media of the mixed-media dataset may be presented; combinations thereof, or the like.

The one or more generative machine-learning models may include any of the aforementioned machine-learning models including, but not limited to, neural networks (e.g., convolutional neural networks, recurrent neural networks, etc.), deep learning networks, generative adversarial networks, transformers (e.g., such as, but not limited to large language models, etc.), combinations thereof, or the like. The one or more machine-learning models may include machine-learning models configured to generate an output including text, images, audio segments, video segments, interactive media (e.g., video games, web-based media, etc.), webpages, combinations thereof, or the like from an input that includes text, images, audio segments, video segments, interactive media (e.g., video games, web-based media, etc.), webpages, combinations thereof, or the like, where the input and output may be of a same media type or different media types. For example, the one or more machine-learning models may receive a feature vector representing a text prompt as input and generate an output including a set of images. For another example, the one or more machine-learning models may receive a feature vector representing an image and generate an output including a set of images.

The media generator may use different machine-learning models depending on an input media type (e.g., text, images, audio segments, video segments, interactive media (e.g., video games, web-based media, etc.), webpages, combinations thereof, or the like) and the output media type requested (text, images, audio segments, video segments, collateral, interactive media (e.g., video games, web-based media, etc.), webpages and/or documents therefor, combinations thereof, or the like). The media generator may include a genvisor configured to select particular machine-learning models to process a particular input. The genvisor may route input features vectors to machine-learning models that are capable of processing the input feature vectors and configured to generate a requested output. For example, the genvisor may select a large language model to process a text prompt that is to generate a text output. The genvisor may select a generative adversarial network or transformer to process a text prompt that is to generate an image output.

In some instances, the one or more generative machine-learning models may be the same one or more machine-learning models of the data controller. In other instances, the one or more generative machine-learning models may be different machine-learning models from the one or more machine-learning models of the data controller. The one or more generative machine-learning models may be trained using a training dataset derived at least in part from the mixed-media dataset. The mixed-media dataset may be segmented based on media type and/or content of the media to define training datasets that may be tailored to the particular generative machine-learning model being trained. For instance, a large language model may be trained using textual portion of the mixed-media dataset and an image generator machine-learning model may be trained using images of the mixed-media dataset.

In some instances, training dataset may be the mixed-media dataset. In other instances, such as when the generative machine-learning models are configured to generate media for other mixed-media datasets or the mixed-media dataset is too small, the training dataset may include additional data such as, but not limited, media of a same or similar type as the media of the mixed-media dataset, media of a same genre or subject, manually-generated media or data, procedurally-generated media or data, metadata, combinations thereof, or the like. The one or more generative machine-learning models may be trained for a predetermined time interval, predetermined quantity of iterations, and/or until the one or more accuracy metrics are reached (e.g., such as, but not limited to, accuracy, precision, area under the curve, logarithmic loss, F1 score, mean absolute error, mean square error, or the like).

The data controller and media generator may operate as a type of generative adversarial network in which the media generator may generate media based on a mixed-media dataset and the data controller may determine the generated media complies with the mixed-media dataset (e.g., does not include contextual details that conflict with or deviate from the contextual details of the mixed-media dataset, etc.). The output of media generator may be used as input to the data controller and the output from the data controller may be used as input to the machine-learning models of the media generator (e.g., to modify media generated by the media generator, train the machine-learning models of the media generator, etc.).

For example, the media generator may receive input requesting generation of a set of webpages that present information about a comic book series. The media generator may define a feature vector from the request and execute the machine-learning models of the media generator using the feature vector or generate the set of webpages (e.g., in series, partially in series and partially in parallel, or in parallel) and output the set of webpages to the data controller. The data controller may generate feature vectors for each webpage of the set of webpages (or a feature vector for two or more webpages of the set of webpages and execute the one or more machine-learning models of the data controller using the feature vectors. The data controller may determine whether the webpages include contextual details associated with the comic book series that comply with the mixed-media dataset representing the comic book series (e.g., the canon of the comic book series, etc.). The data controller may transmit the output from the machine-learning models to the media generator. The media generator may define feature vectors using, the output from the data generator, the initial input to the machine-learning models of the media generator, the set of webpages, an identification of any webpages of the set of webpages that do not comply with the mixed-media dataset, combinations thereof, or the like. The media generator may then execute the one or more generative machine-learning models again using the feature vectors to generate a modified set of webpages. This process may continue until the data controller determines that the set of webpages complies with the mixed-media dataset. The set of webpages may then be output to a remote device for hosting. Alternatively, the media generator may generate media for presentation through a webpage hosted by another device. For example, the media generator may generate blog posts, social medial posts, encyclopedia entries, entries for online publication, entries in a crowdsourced and/or community-edited publication (e.g., such as, but not limited to, Wikipedia® or other wiki publications, etc.).

In an illustrative example, a computing device (e.g., operating a data controller, etc.) may receiving an identification of one or more media assets. Each media asset of the one or more media assets may represent a set of related media. In some examples, a media asset may represent a single creative narrative (e.g., such as, but not limited to, a graphic novel, comic book, book, or other work), a series of creative narratives, a character of a creative narrative, subject of creative narratives (e.g., superheroes, etc.), genre of creative narratives (e.g., fiction, non-fiction, mystery, manga, science fiction, etc.), media type (e.g., text, images, audio segments, video segments, interactive media (e.g., video games, web-based media, etc.), webpages, combinations thereof, or the like), symbol, theme, plot detail, combinations thereof, or the like. The media asset may be used to identify a set of media that are related to the media asset. For example, a media asset that represents a character may be used to identify a set of media (e.g., related media) that includes the character.

The computing device may generate a training dataset based on the identification of one or more media assets. The training dataset may include a subset of the set of related media of each media asset of the one or more media assets. In some instances, the training dataset may include one or more contextual details (e.g., extracted by a data controller from the set of related media, etc.) that define a canon of a media asset (e.g., a curated set of media and/or details that correspond to the media asset and define a scope of the media asset). A contextual detail may correspond to a detail of media of a media asset such as, but not limited to, an identification of a title, an identification of a character, a fact associated with the media asset or a component thereof, a fact associated with the related media of the media asset, biography and/or demographic information of a character, a setting or a location associated with the media asset or related media thereof, a plot detail, details associated with a wardrobe worn by a character (e.g., such as colors, shapes, patterns, etc.), a theme, a symbol, tone, an intent of a character, an emotion experienced by a character, symbolism, combinations thereof, or the like.

In some examples, the computing device may generate one or more training datasets with each training dataset being tailored for a particular machine-learning model. The training datasets may be tailored by selecting: the related media of the set of related media, selecting related media of the set of related media that corresponds to a particular media type, contextual details, metadata (e.g., including production information such as publication date, publication company, company information, location, data size, etc.), combinations thereof, or the like based on the particular machine-learning model being trained. For instance, the computing device may generate a first training dataset including a textual portion of the training dataset for a large language model and a second training dataset including images and video from set of related media for an image generator machine-learning model.

In some examples, the training dataset may include an identifier that corresponds to at least one of the one or more media assets. The identifier may be an identifier of a media asset, a characteristic of the media asset, a globally unique identifier, a hash, and/or the like. The computing device may identify the training dataset using the identifier. Alternatively, or additionally, the computing device may dynamically derive the training dataset using the identification of the one or more media assets. For example, the computing device may use an identifier of a media asset to identify a set of media that corresponds to that media asset. The computing device may then generate the training dataset from the set of media by extracting contextual details from the set of media using one or more machine-learning models.

The training dataset may include the set of media associated with the one or more media assets, labels (e.g., for supervised learning, etc.), contextual details extracted from the set of media associated with the one or more media assets, metadata, combinations thereof, or the like. The set of media may include media corresponding to one or more media types such as, but not limited to, text, audio segments, images, video segments, interactive media (e.g., video games, web-based media, etc.), webpages, combination thereof, or the like. In some instances, the training dataset may be augmented with additional data associated with or related to the one or more media assets such as data derived from the training dataset (e.g., inferences, predictions, classifications, etc.). In some instances, such as when the training dataset is too small, the additional data may include, but is not limited to, data similar to or related to the media asset, manually generated data associated with the media asset, procedurally generated data associated with the media asset, and/or the like.

The computing device may train a machine-learning model using the training dataset. The machine-learning model may a single model, multiple machine-learning models, an ensemble model, and/or the like configured to generate media associated with a particular media asset of the one or media assets. Examples of machine-learning models include, but are not limited to, neural networks (e.g., such as recurrent neural networks, long short-term memory (LSTM), mask recurrent neural networks, convolutional neural networks, faster convolutional neural networks, etc.), deep learning networks, you only look once (YOLO), EfficientDet, deep learning networks, transformers (generative pre-trained transformers (GPT), Bidirectional Encoder Representations from Transformers (BERTs), text-to-text-transfer-transformer (T5), etc.), generative adversarial networks (GANs), recurrent gated units (GRUs), combinations thereof, or the like. The machine-learning model may be trained using supervised learning, unsupervised learning, semi-supervised learning, transfer learning, reinforcement learning, combinations thereof, or the like. The computing device may train the machine-learning model for a predetermined time interval, predetermined quantity of iterations, and/or until the one or more accuracy metrics are reached (e.g., such as, but not limited to, accuracy, precision, area under the curve, logarithmic loss, F1 score, a longest common subsequence (LCS) such as ROUGE-L, Bilingual evaluation Understudy (BLEU) mean absolute error, mean square error, or the like).

The computing device may then receive a request to generate media representing a media asset of the one or more media assets. The request may include an identification of a particular media asset and a media type. In some instances, the computing device may also include an identification of a quantity of media to generate. For example, the request may indicate a quantity of images to generate, a quantity of words, a video segment length, an audio segment length, a quantity of webpages, etc.). In some examples, the request to generate media may include a prompt usable as input into the machine-learning model. In other instances, a prompt may be derived from the request. For example, the request may include a selection of a media asset, a media type, etc. and generate the prompt usable as input to the machine-learning model. The prompt may be generated using the machine-learning model, another machine-learning model, user input, an algorithm, combinations thereof, or the like.

The computing device may execute the machine-learning model using a feature vector derived at least in part from the identification of the particular media asset and the media type. The machine-learning model may generate media associated with the particular media asset and of the media type. For some media types, the output of the machine-learning model may be a specification that defines media of the media type. For instance, for webpage media, the output from the machine-learning model may be document including hypertext markup language instructions, JavaScript instructions, cascading style sheets instructions, or the like that may define a webpage. The webpage may be hosted by the computing device and/or other host service and rendered by a browser. Alterntively, or additionally, the output may be a document including media for presentation through a webpage hosted by separate device. In those instances, the document may be transmitted to the separate device and included within the webpage.

In some examples, the computing device may process the output before transmitting (or presenting) the output to the requesting device. The computing device may transmit the output to a data controller for authentication. The data controller may generate a feature vector from the output of the machine-learning model (or a feature vector for each media including in the output) and execute a second machine-learning model using the feature vector. The data controller may authenticate the output by determining whether the output complies with the portion of the training dataset that corresponds to the particular media asset. For example, the data controller may determine if the output includes contextual details that conflict with the portion of the training dataset that corresponds to the particular media or deviate from the portion of the training dataset that corresponds to the particular media by more than a threshold (e.g., determined based on a distance between the output and portion of the training dataset using Euclidean distance, Manhattan distance, Minkowski distance, Hamming distance, combinations thereof, or the like). The second machine-learning model may generate a conflict report identifying any conflict or deviation that is greater than the threshold. The data controller may transmit the conflict report to the machine-learning model to retrain and/or improve the machine-learning model.

If the conflict report identifies a conflict or deviation that is greater than the threshold, then the computing device may execute a reinforcement or retraining iteration of the machine-learning model. Alternatively, or additionally, the computing device may re-execute the machine-learning model using a new feature derived from the feature vector and the conflict report to generate a new media output. The new media output may be passed to the data controller for authentication and the process may continue until the data controller outputs a conflict report that does not identify any conflicts or deviations greater than the threshold.

The computing device may facilitate a presentation of at least a portion of the media. In some instances, facilitating the presentation of at least a portion of the media may include transmitting the at least a portion of the media (or all of the media) to the requesting device. In other instances, facilitating the presentation of at least a portion of the media may include displaying the at least a portion of the media (or all of the media) via a display of the computing device, a display connected to the computing device, a display of another device such as, but not limited to, the requesting device. In still yet other instances, facilitating the presentation of at least a portion of the media may include storing the at least a portion of the media (or all of the media) for access by the requesting device and/or other devices. For example, the at least a portion of the media (or all of the media) may be stored by a hosting service that may present the at least a portion of the media (or all of the media) upon request.

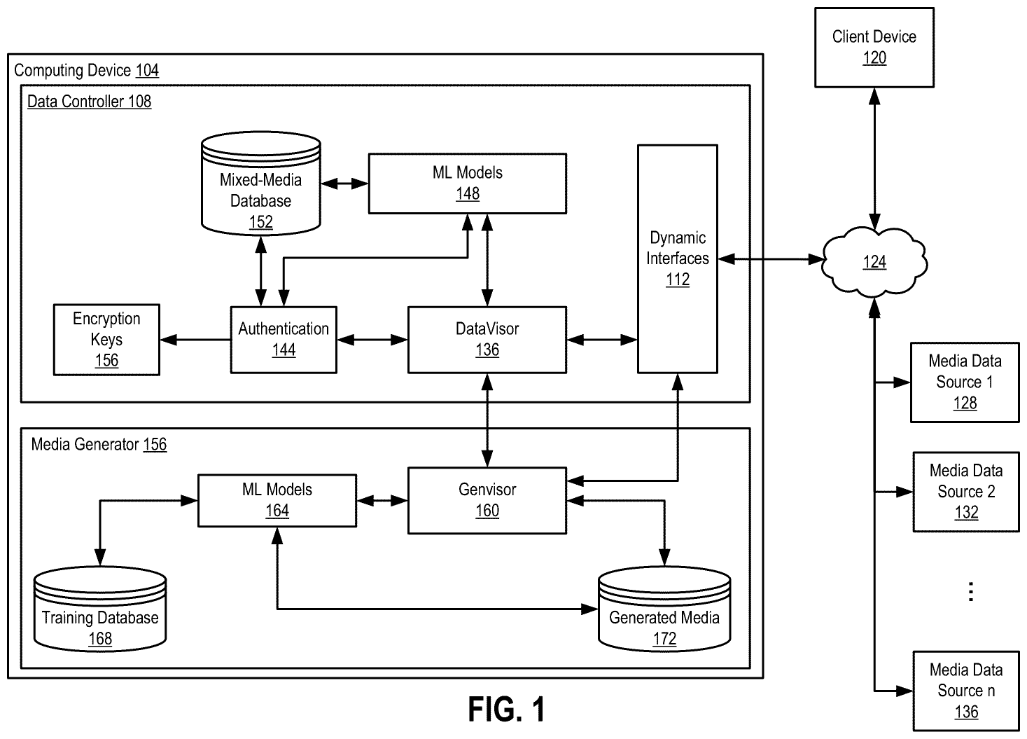

FIG. 1 illustrates a block diagram of an example media generation system that facilitates generation of media based on mixed-media datasets according to aspects of the present disclosure. Media generation system 100 may generate media based on statically and/or dynamically defined mixed-media datasets. A mixed-media dataset may include a representation of one or more text, images, video segments, interactive media (e.g., video games, web-based media, etc.), webpages, audio segments, combinations thereof, or the like that is associated with a media asset (e.g., an identification of a character, title, series (e.g., a comic book series, television series, film series, book series, etc.), author, etc.) that can be representative of a set of media.

Computing device 104 may be hardware processing node in media generation system 100. In some instances, computing device 104 may be one of a set of hardware processing nodes allowing for distributed media generation, write protection, management of distributed datasets, load balancing, etc. Computing device 104 may include processing hardware including processors, volatile and non-volatile memories, graphics processing units (GPUs), etc. Computing device 104 may include data controller 108, which may manage requests from remote devices requesting to generate media and authenticate generated media. Data controller 108 may also facilitate media generation by managing the operations of media generator 156. In some instances, data controller 108 may be a hardware component that operates within computing device 104 such as, for example, a field programmable gate array, application specific integrated circuit, microcontroller, combinations thereof, or the like. In other instances, data controller 108 may be a software component executed by the processing hardware of computing device 104. In still yet other instances, data controller may be a hardware component and a software component in which some operations of data controller 108 may be facilitated by the hardware component and some operations of data controller 108 may be facilitated by the software component. In those instances, the software component may be executed by the hardware component, by the processing hardware of computing device 104, by the processing hardware of another computing device, combinations thereof, or the like.

Data controller 108 may include dynamic interfaces 112, which may operate interfaces enabling communication with disparate devices and interfaces presenting controls of data controller 108 to users of computing device 104 (e.g., users directly connected to computing device 104, users of client device 120 and/or other client devices, users of media data sources (e.g., 124-132). Dynamic interfaces 112 may include one or more predefined interfaces and instructions for generating dynamic interfaces in response communications received via network 116 (e.g., cloud network, local area network or wide area network, the Internet, etc.). For example, dynamic interfaces 112 may define custom interfaces for particular device types (e.g., such as mobile devices, desktop devices, accessibility devices, etc.) to enable uniform presentation of data and uniform interactions with data controller 108.

Data controller 108 may receive requests from remote devices through dynamic interfaces 112 to define mixed-media datasets, generate media, access mixed-media dataset, determine media compliance with mixed-media datasets, and/or modify mixed-media datasets. Some mixed-media datasets may be statically defined and stored in a database of computing device 104 or a database that is accessible to computing device 104. Some mixed-media datasets may be dynamically defined based on a definition of a media asset. For example, the computing device may identify datasets that correspond to the media asset (e.g., stored in local memory or stored in one or more media data source 124-132, etc.) and define a mixed-media dataset that corresponds to the media asset based on the identified datasets. The request may include authentication data (e.g., a token, access credentials such as a username and password, encryption key, etc.), an operation to perform on a mixed-media dataset (e.g., access, modification, media generation, compliance, etc.), an identification of media generation parameters (e.g., media type, media length, constraints, etc.), an identification of a media asset, combinations thereof, or the like.

Datavisor 136 may manage the operations of data controller 108. When a request is received datavisor 136 may authenticate the request (and/or the requesting device or user, etc.) using the authentication data according to the access privileges of the media asset identified in the request and initiate execution of the operation identified in the request. The access privileges may be defined by the one or more media data sources (124-132) that store or manage the media asset. Access privileges may indicate whether particular credentials are needed to access the mixed-media dataset, whether access is limited to particular devices or device types, etc. If the requesting devices requires authentication based on the access privileges of the mixed-media dataset, datavisor 136 may pass the request to authentication 144. Authentication 144 may use the authentication data in the request to authenticate the requesting device based on one or more of: the authentication data, an identification of the requesting device or user, the operation identified by the request, or the like.

Once authenticated, authentication 144 may retrieve the mixed-media dataset and/or data derived from the mixed-media dataset (e.g., such as a training data, feature vectors, etc.) corresponding to the request. If the mixed-media dataset and/or data derived from the mixed-media dataset is encrypted, authentication 144 may use encryption keys 148 to identify one or more encryption keys associated with the mixed-media dataset and/or data derived from the mixed-media dataset. The encryption keys and/or the authentication data may be used to decrypt the mixed-media dataset and/or data derived from the mixed-media dataset. In some instances, only the encryption key is needed to decrypt the mixed-media dataset and/or data derived from the mixed-media dataset. In other instances, the encryption key and the authentication data are combined (e.g., via a bitwise operation, appending the encryption key to the authentication data, as a hash, etc.) to decrypt the mixed-media dataset and/or data derived from the mixed-media dataset. Authentication 144 may transmit the mixed-media dataset to datavisor 140.

For media generation requests, data controller 108 may transmit an identification of the media generation operation, the media generation parameters, and the mixed-media dataset and/or data derived from the mixed-media dataset, combinations thereof, and/or the like to media generator 156. In some instances, media generator 156 may be a hardware component that operates within computing device 104 such as, for example, a field programmable gate array, application specific integrated circuit, microcontroller, combinations thereof, or the like. The hardware component of media generator 156 may operate in parallel with data controller 108, as a subcomponent of data controller 108, as a distributed component included within the computing device 104 and/or one or more other devices, combinations thereof, or the like. In other instances, media generator 156 108 may be a software component executed by the processing hardware of computing device 104 or by the hardware component of data controller 108. In still yet other instances, media generator 156 may include a hardware component and a software component in which some operations of media generator 156 may be facilitated by the hardware component and some operations of media generator 156 may be facilitated by the software component. In those instances, the software component may be executed by the hardware component of media generator 156, by the hardware component of data controller 108, by the processing hardware of computing device 104, by the processing hardware of another computing device, combinations thereof, or the like.

Genvisor 160 may manage processes that generate media. A media generation request may be received from a remote device (e.g., one or more media data source 128-136, client device 120, other device, etc.). Genvisor 160 may receive media generation requests from data controller 108 and/or directly from dynamic interfaces 112, facilitate generation of the requested media, and transmit the generated media to datavisor 140 for validation. Upon passing validation, datavisor 140 may transmit the generated media to the requesting device and/or user through dynamic interfaces 112. Genvisor 160 may also manage the models that generate the media including training, execution, post-execution training, instantiation (e.g., replacing trained models with new models, etc.), etc. Genvisor 160 may instantiate a model for a particular media asset to generate media that corresponds to the media asset. For example, genvisor 160 may receive a request to generate media corresponding to a particular media asset. Genvisor 160 may identify a model trained to generate media that corresponds to the media asset or train a new model to generate media that corresponds to the media asset using a training dataset include media that corresponds to the media asset. Alterntively, or additionally, genvisor 160 may instantiate a model configured to generate media that corresponds to one or more media assets such as a generative pre-trained transformer, etc. that may be configured to generate media or other content corresponding to various media assets.

A media generation request may include an identification of a media asset, a media type of media to be generated, one or more parameters associated with the media generation process and/or the media to be generated, combinations thereof, and/or the like. For example, the media generation request for a comic book series media asset for an advertisement campaign may include an identification of the comic book series (e.g., the media asset), an identification of the media type (e.g., images, webpages, video segments, audio segment, etc.), one or more parameters (e.g., an identification the advertising campaign, promotion phrases and/or features, text to include, quantity of media to generated (e.g., quantity of unique images, video segment length, audio segment length, etc.), combinations thereof, etc.), etc. Genvisor 160 may then configure a machine-learning model (or identify a machine-learning model) capable of generating an advertisement campaign associated with the comic book series. In another example, the media generation request for wiki for a comic book series media asset, an identification of the media type (e.g., images, text, etc. for one or more webpages), one or more parameters (e.g., a quantity of webpages to include in the wiki, a degree of scope of each page, plot details or other contextual details to include in the wiki or exclude from the wiki, etc.), combinations thereof, etc. Genvisor 160 may then configure a machine-learning model (or identify a machine-learning model) capable of generating a wiki of the comic book series.

Genvisor 160 may determine if a machine-learning model of ML models 164 is trained to generate media corresponding to the media asset and/or the media type. If such machine-learning model is trained, genvisor 160 may train a new machine-learning model to satisfy the media generation request. Genvisor 160 may select a particular model type based on the media type, media asset, one or more parameters, availability of training data for the new machine-learning model, etc. Genvisor 160 may then obtain training data usable to train the new machine-learning model from training data 168. Examples of machine-learning models that may be included in ML models 140 include, but are not limited to, neural networks (e.g., such as recurrent neural networks, long short-term memory (LSTM), mask recurrent neural networks, convolutional neural networks, faster convolutional neural networks, etc.), deep learning networks, you only look once (YOLO), EfficientDet, deep learning networks, transformers (generative pre-trained transformers (GPT), Bidirectional Encoder Representations from Transformers (BERTs), text-to-text-transfer-transformer (T5), or the like), generative adversarial networks (GANs), recurrent gated units (GRUs), combinations thereof, or the like.

Training database 168 may store mixed-media datasets, a representation of mixed-media datasets, a link to mixed-media datasets (e.g., such as pointer, URL, or the like), an identification of media that may be included in a mixed-media dataset, a link to media that may be included in a mixed-media dataset, training datasets (e.g., a representation of a mixed-media dataset usable to train a machine-learning model and/or usable by a machine-learning model to define a canon associated with a media asset), metadata, labels (e.g., for supervised learning, semi-supervised learning, self-supervised learning, reinforcement learning, etc.), combinations thereof, or the like. For example, training database 168 may include a reference to media stored in one or more media data sources 124-132 that may be used by genvisor 160 to define a mixed-media dataset associated with a particular media asset usable to train the new machine-learning model. Alternatively, or additionally, genvisor 160 may request a mixed-media dataset usable to train the new machine-learning model (or some portion thereof), from datavisor 140.

Genvisor 160, may train the new machine-learning model using supervised learning, unsupervised learning, semi-supervised learning, transfer learning, reinforcement learning, combinations thereof, or the like. The new machine-learning model may be trained for a predetermined time interval, predetermined quantity of iterations, and/or until one or more accuracy metrics are reached (e.g., such as, but not limited to, accuracy, precision, area under the curve, logarithmic loss, F1 score, mean absolute error, mean square error, or the like).

Genvisor 160 may define a feature vector from the media generation request and execute selected machine-learning model (such as a pre-trained machine-learning model and/or the new machine-learning model, etc.) using the feature vector. The generated media may be associated with the media asset. For example, the generated media may include characters associated with the media asset, including contextual details associated with the media asset, may include a same animation style, include the same or similar color schemes and/or clothing, etc. Genvisor 160 may transmit the generated media to datavisor 140 for validation. The transmission may include an identification of the mixed-media dataset and/or an instance of the mixed-media dataset for datavisor 140 to validate the generated media against.

Data controller 108 may initiate ML models 140 to determine if the generated media complies with the mixed-media dataset (e.g., whether the generated media includes contextual details that conflict with or deviate from the contextual details of the mixed-media dataset, etc.). Data controller 108 may use the identification of the mixed-media dataset to retrieve the mixed-media dataset from mixed-media database 152. If an instance of the mixed-media dataset is included in the transmission from genvisor 160, then datavisor 140 may store the mixed-media dataset in mixed-media database 152.

Mixed-media database 152 may store mixed-media datasets, a representation of mixed-media datasets, a reference to mixed-media datasets (e.g., such as pointer, URL, or the like), an identification of media that may be included in a mixed-media dataset, a link to media that may be included in a mixed-media dataset, training datasets, metadata, labels, combinations thereof, or the like. Mixed-media database 152 may generate mixed-media datasets based on identifiers received from datavisor 140. Mixed-media database 152 may store the mixed-media dataset from datavisor 136.

Datavisor 136 may manage the training, initiation, and execution of machine-learning (ML) models 140. ML models 140 may include one or more machine-learning models configured to validate the media generated by media generator 156. The one or more machine-learning models may include any of the aforementioned types of machine-learning models. In some instances, the one or more machine-learning models may include the machine-learning models described in connection with ML models 164. In other instances, the one or more machine-learning models may be different machine-learning models.

Datavisor 136 may train a machine-learning model using a training dataset identified by mixed-media database 152 or media generator 156. In some instances, the training dataset may be the mixed-media dataset or a representation of the mixed media dataset, a dataset derived using the identification of the media asset included in the request, or the like. In other instances, the training dataset may be a general dataset (e.g., not necessary including data of the mixed-media dataset or related thereto, etc.). The one or more machine-learning models of ML models 148 may be trained to identify contextual details from an input media (e.g., received from an external device, generated media received from media generator 156, etc.), determine if the input media complies with a mixed-media dataset, etc. For example, the mixed-media dataset may represent a canon of contextual details associated with a media asset. The one or more machine-learning models of ML models 148 may be configured to determine a degree of deviation between an input feature vector derived from a media segment (e.g., media generated by media generator 156, etc.) and the training dataset (or the mixed-media dataset). A degree of deviation that is greater than a threshold may indicate that the media segment includes contextual details that conflict with (e.g., contradict) or are too different from the contextual details of the training dataset (or the mixed-media dataset) (e.g., such as an integer value representing different by more than a threshold amount, etc.).

The one or more machine-learning models of ML models 148 may be trained using supervised learning, unsupervised learning, semi-supervised learning, transfer learning, reinforcement learning, combinations thereof, or the like. The one or more machine-learning models of ML models 148 may be trained for a predetermined time interval, predetermined quantity of iterations, and/or until one or more accuracy metrics are reached (e.g., such as, but not limited to, accuracy, precision, area under the curve, logarithmic loss, F1 score, mean absolute error, mean square error, or the like).

Once trained (or if datavisor 136 identified one or more already trained machine-learning models that are configured to process the request), datavisor 136 may derive a feature vector from generated media from media generator 156. The feature vector may include a media segment or contextual details that may be compared to the training dataset (or mixed-media dataset) to determine the degree of deviation between the media segment or contextual details and the training dataset (or the mixed-media dataset). Datavisor 136 may select one or more machine-learning models to execute using the feature vector based on a media type (e.g., text, images, audio, video, etc.), an identification of the media asset, the mixed-media dataset, combinations thereof, or the like. Datavisor 136 may schedule the execution of the one or more machine-learning models. The one or more machine-learning models may be executed individually or in groups (e.g., in series, in parallel, and/or partially in series and partially in parallel, etc.).

Datavisor 136 may receive the output from the one or more machine-learning models and determine whether the generated media can be validated. For example, if the degree of deviation is greater than a threshold, then the datavisor 136 may transmit a communication to genvisor 160 indicating the generated media fails validation (e.g., does not comply) with (e.g., the canon of) the mixed-media dataset. Alternatively, the datavisor 136 may request user input to resolve the failed validation. For example, user input may be received approving the generated media. The user input may approve updating the mixed-media dataset by adding the generated media to the training dataset (or mixed-media dataset), replacing media or contextual details of the training dataset (or mixed-media dataset) that conflict with the generated media, etc. If the degree of deviation is less than the threshold (e.g., the validation passed), than datavisor 136 may output the generated media.

Datavisor 136 may transmit an indication of the validation to the device that requested the generated media. If generated media passes validation, then datavisor 136 may output the generated media to the device that requested the generated media. If the generated media fails validation (e.g., datavisor 136 transmits an indication that the generated media failed validation to genvisor 160), genvisor 160 may use the output from the one or more machine-learning models 148, the indication that the generated media failed validation, the input used to generate the generated media, the generated media, combinations thereof, and/or the like, to execute a training iteration (e.g., retraining, reinforcement, etc.) that modifies the machine-learning model of ML models 164 that generated the generated media to improve subsequent media generated by the machine-learning model. Genvisor 160 may then generate a new version of the generated media and transmit the new version of the generated media to datavisor 140 for validation. Alternatively, genvisor 160 may generate a new version of the generated media and transmit the new version of the generated media to datavisor 136 for validation without executing a training iteration. The generation of the new version of the generated media may modify the machine-learning model to improve subsequent media generated by the machine-learning model.

In some instances, datavisor 136 may transmit an indication that the generated media passes validation to genvisor 160. Genvisor 160 may use the output from the one or more machine-learning models 148, the indication that the generated media passed validation, the input used to generate the generated media, the generated media, combinations thereof, and/or the like, to execute a training iteration (e.g., retraining, reinforcement, etc.) that modifies the machine-learning model of ML models 164 to improve subsequent media generated by the machine-learning model.

The generation of media by media generator 156 and validation by data controller 108 may be an iterative process in which media is generated by media generator 156, the media is validated by data controller 108 and returned to media generator 156 to improve media generation, etc. until the data controller 108 determines that the generated media passes validation. A description of the data controller and related processes can be found in U.S. application Ser. No. 18/607,015 filed Mar. 15, 2024, which is incorporated herein by reference in its entirety for all purposes.

Dynamic interfaces 112 may generate an interface to represent the output received from datavisor 136 and provide one or more controls usable to modify the media segment (e.g., to reduce the deviation between the media segment and the training dataset or mixed-media dataset), provide information about the training dataset or mixed-media dataset (e.g., such as, but not limited to, an identification media included in the training dataset or mixed-media dataset, an identification contextual details, labels, metadata, timestamps, etc.), provide visual representations of the media segment, provide visual representations of the training dataset (or mixed-media dataset), combinations thereof, or the like. In some instances, the interface may be modified by datavisor 136 and/or user input to include additional controls.

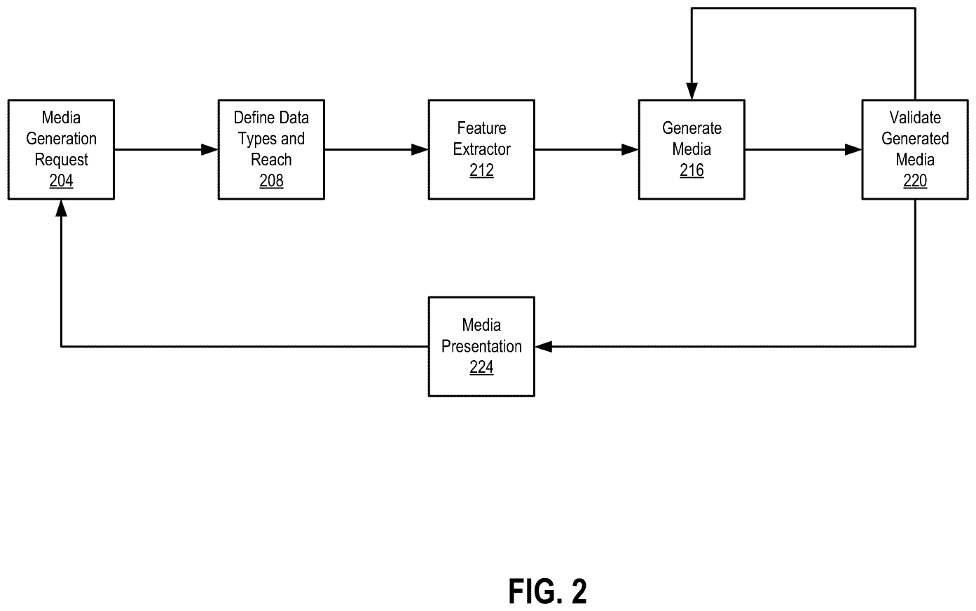

FIG. 2 illustrates a block diagram of an example process of generating media based on mixed-media datasets for according to aspects of the present disclosure. At 204, a computing device may receive a media generation request. The computing device may be computing device 104 of FIG. 1 and/or another device configured to execute or facilitate execution of the media generation request. The media generation request may include information to facilitate the media generation request including, but not limited to, an identification of a media asset, a media type (e.g., text, images, video segments, audio segments, webpages, interactive media such as video games, combinations thereof, or the like) or multiple media types (e.g., for generating mixed-media or a set of media, etc.), one or more parameters, an identification of media to be included in the generated media, an identification of media to be used to generate the media (e.g., a mixed-media dataset, media, etc.) combinations thereof, or the like. For example, a media generation request may identify a media asset (e.g., such as a comic book, etc.) to generate media that is similar to or corresponds to the media asset. The media generation requestion may generate promotional media (e.g., advertisements, etc.) that promote the media asset or a media thereof, wiki's (e.g., such as one or more documents including contextual details and/or of the media asset or media thereof, etc.), related media (e.g., new media of the media asset and/or alternative versions of media of the media asset, etc.) in same or similar style, etc.

At 208, the computing device may define data types and/or intended reach of the generated media. Alternative, or additionally, the computing device may receive a definition of the data types and/or the intended reach from a remote device and/or via user input. Data types may refer to a media type, a file type, and/or the like. For example, a promotional media generation request may include generating images that may promote a media asset. The computing device may define the data types of the images as a Joint Photographic Experts Group (JPEG) or Portable Network Graphics (PNG), or the like. In some instances, the data type may be defined based on a subsequent transmission or presentation of the images. For example, if the images are to be presented via a graphical user interface, the computing device may define a first type and if the images to be presented via a webpage, the computing device define a second type. Reach may correspond to a distribution of the generated media such as environments that may host or present the generated media, geographical locations, etc. For example, a reach may indicate that the generated media may be presented in the United States and in Japan. The reach may be usable by the media generator to generate media tailored to satisfy the reach. Returning to the previous example, the generated media may include text and/or audio segments in languages used in the United States (e.g., English, Spanish, etc.) and Japan (e.g., Japanese). In some instances, the reach may also cause the media generator to tailor generated media to environments which may present the generated media such as webpages, web applications, printed formats (e.g., comic books, books, posters, flyers, etc.), video segments, etc.

At 212, the computing device may extract features from the media generation request, the definition of the data types, and/or the definition of the reach. Features may be extracted by a machine-learning model (e.g., prompt generator, natural language processor, transformer, etc.), one or more algorithms, decision tree, user input, and/or the like. In some examples, the feature vector may include a prompt (e.g., a text string, dataset, etc.) generated from the media generation request, the definition of the data types, and/or the definition of the reach. The feature vector may be transmitted to the media generator and at 216 the media generate may generate media based on the feature vector. The generated media may be in a format according the defined data type and reach of 208.

At 220, the generated media may be validated (by a data controller) to determine if the generated media complies with the mixed-media dataset that corresponds to the media asset of the media generation request. For example, the data controller may determine if the generated media includes contextual details that conflict with the mixed-media dataset (e.g., representing a canon or scope of the media asset, etc.) or deviates from the mixed-media dataset by more than a threshold amount.

If the generated media is validated (e.g., the generated media complies with the mixed-media dataset), then the generated media be presented at 224. The generated media may be presented based on the media generation request. For instance, if the media generation request included a request for a wiki, then the generated media may include a document (or set of documents) that may include HTML, JavaScript or other code that may enable presentation of the documents as a webpage (or set of webpages). The documents may be hosted by the computing device, a server, or other device to enable presentation of the documents to one or more devices and/or users. If the media generation included a request for print promotional material, the presentation at 224 may include printing the generated media in a format identified by the media generation request (e.g., poster, flyer, etc.). In some instances, the presentation at 224 may include distribution of the generated media over a communication protocol, via one or more webpages, email, an application, via a physical distribution medium (e.g., mail, etc.), other media (e.g., embedded within other media, etc.), combinations thereof, or the like.

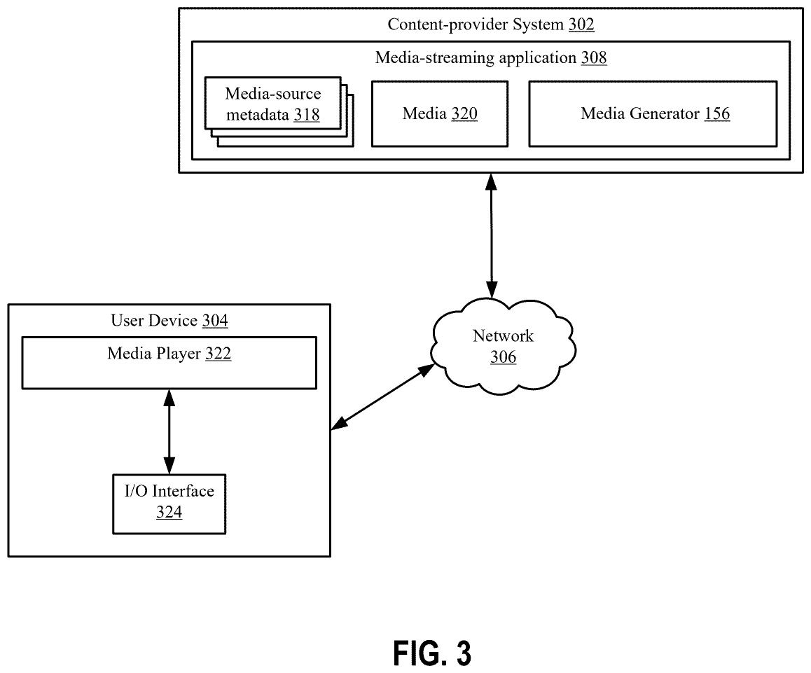

FIG. 3 illustrates a block diagram of an example media generation system configured to generate media based on mixed-media datasets according to aspects of the present disclosure. Content provider system 302 includes an implementation of media generator 160 (as described in connection to FIG. 1) that operates within a remote environment (e.g., content-provider system 302). User device 304 may be a computer (e.g., desktop, laptop computer), mobile device (e.g., smartphone, tablet, e-reader, etc.), display device (e.g., television, monitor, etc.), or the like. User device 304 may include processing hardware (e.g., central processing unit, graphical processing unit, volatile and/or non-volatile memories, input/output interfaces, network interfaces, etc.) to enable presentation of graphical media (e.g., via media player 322 or another application). User device 304 may receive input from one or more input/output devices through I/O interface 224 usable to control operation of user device 304 and media player 322. Example input/output devices include, but are not limited to, a keyboard and/or mouse, camera (e.g., for eye tracking, gestures, etc.), touch interface (e.g., capacitive touchscreen, or the like for touch-based gestures, etc.), motion sensors (e.g., accelerometers, gyroscopes, etc. configured to measure motion in one or more axes), a microphone (e.g., for speech recognition and voice commands, etc.), a display, and/or the like. Different user devices may include different input/output devices. The particular input/output devices included in a user device may depend on the user device type. For instance, a mobile device, such as a smartphone, may include a camera, touch interface, motion sensors, etc. but exclude a keyboard or mouse. A desktop computer may include a keyboard and mouse but exclude a touch interface and motion sensors.

Content-provider system 302 may store graphical media 320, media-source metadata 318 associated with graphical media 320, and an instance of media generator 156. Graphical media 320 may be generated by media generator 156 or received by content-provider system 302 for distribution to user device 304 and/or other user devices (not shown). User device 304 may transmit a request for graphical media through network 306 and in response, content-provider system 302 may transmit the requested graphical media to user device 304 (or cause the graphical media to be transmitted to user device 304 if not stored locally be content-provider system 304). Media-source metadata 318 may store metadata associated with graphical media. The metadata may include information associated with the creation of the metadata (e.g., author, publishing date, location, etc.), contextual details extracted from the graphical media and forming a canon (e.g., such as, but not limited to, information associated with characters, plots, themes, symbols, symbolism, related media, etc.), technical information (e.g., such as file types, file sizes, image resolution, aspect ratios, color information, etc.), features that may be usable by machine-learning models of media generator 156, and/or the like. The metadata may be transmitted with graphical media requested by user device 304 to improve processing of the graphical media and to provide additional information associated with the graphical media.

In some instances, media generator 156 may be implemented as a software component that may be executed by media-streaming application 308. In other instances, data controller 108 may be implemented as a hardware component such as an application-specific integrated circuit, field programmable gate array, mask programmable gate array, or as set of interconnected components (e.g., such as central processors, graphical processing units, memory, microcontrollers, etc.), that execute operations described herein. For instance, the hardware component may include a thread scheduler that selects the processing of instructions to content-provider system 302 or the hardware components to improve the processing speeds and/or consumption of processing resources. The hardware component may offload machine-learning processes to a graphics processing unit (GPU) of content-provider system 302, which may more efficiently execute the processes and execute other processes internally. If a processing bottleneck occurs, the hardware component may adaptively route execution of processes to the central processing unit of content-provider system 302 until the processing bottleneck is alleviated. The hardware component may operate as a specialized processing device that may operate within another processing device and selectively use the processing resources of the another processing device for improved operation of the hardware component.

Media generator 156 may be configured to generate media associated with a media asset based on a mixed-media dataset of the media asset. Media generator 156 may include one or more machine-learning models configured to generate various media types associated with the media asset. Examples of media that may be generated by a media generator include, but are not limited to, text, images, video segments (e.g., such as, but not limited to, a trailer associated with the mixed-media dataset or media of the mixed-media dataset, a teaser for media associated with the mixed-media dataset, a movie, a looping video, a music video, an advertisement, a cutscene, such as for a video game associated with the mixed-media dataset, a dynamic typography video, a video configured for a social media platform (e.g., such as resolution, length, frame rate, etc.), an animation (e.g., such as a graphics interchange format, animated portable network graphics, etc.), combinations thereof, and/or the like), interactive media (e.g., video games, web-based media, etc.), webpages and/or documents therefor (e.g., such as, but not limited to, blog posts, encyclopedia entries, entries for an online publication, entries for crowdsourced and/or community-edited publications, instructions such as hypertext markup language or JavaScript, etc.), collateral (e.g., marketing collateral such as promotional media for the mixed-media dataset, media associated with or included in the mixed-media dataset, and/or the like), audio segments, combinations thereof, or the like. The mixed-media dataset may include a curated set of contextual details of the media asset usable to generate media that corresponds to the media asset (e.g., using a same or similar style, color scheme, contextual details, etc.). For example, the media generator 156 may generate promotional media for the media asset (e.g., advertisements in one or more formats such as, but not limited to, physical print media, digital media, webpages, images, video segments, audio segments, etc.), informational media (e.g., media describing and/or explaining the media asset and/or media thereof including, but not limited to, webpages such as a wiki, blog or social media posts, etc.), new or alternative versions of media of the media asset (e.g., media including new plots, symbols, symbolisms, characters, contextual details, etc. that complies with the mixed-media dataset of the media asset), combinations thereof, or the like.

Content-provider system 302 may include a data controller (e.g., such as data controller 108) configured to validate media generated by media generator 156 to prevent the generation of media that does not comply with the mixed-media dataset of the media asset and further improve media generation of media generator 156. The data controller may use a first one or more machine-learning models to extract contextual details from the generated media and compare the contextual details from the generated media to the contextual details of the mixed-media dataset of the media asset (e.g., using an algorithm, the first one or more machine-learning models, a second one or more machine-learning models, user input, combinations thereof, or the like). Data controller 108 would then determine whether the generated data complies with the mixed-media dataset of the media asset. If the generated media complies with the mixed-media dataset, then the generated media may be presented to the requesting device (e.g., user device 304, other device, etc.). If the generated media does not comply with the mixed-media dataset (e.g., the generated media includes contextual details that conflict with the mixed-media dataset or deviate from the mixed-media dataset by more than a threshold amount), then the data controller may output an indication of the failed validation to media generator 156. Media generator 156 may modify the processes used for media generation (e.g., machine-learning models, algorithms, etc.) and generate a new version of the generated media for validation. The process may continue until the media generator 156 generated media that is validated by the data controller or until user input is received interrupting the process.

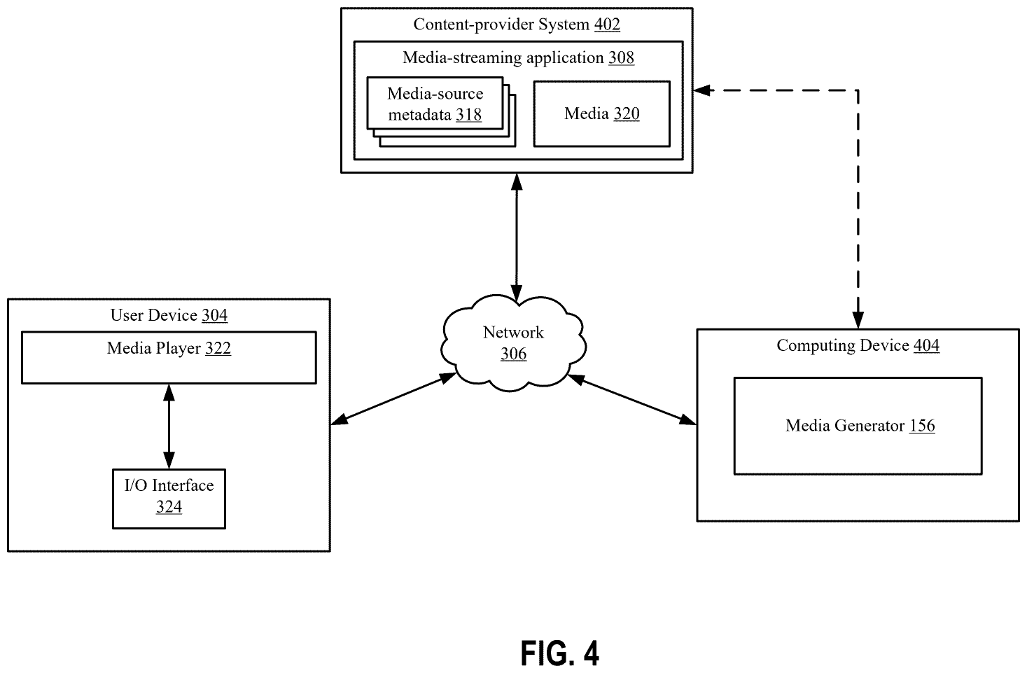

FIG. 4 illustrates a block diagram of an example distributed media generation system configured to generated media based on mixed-media datasets according to aspects of the present disclosure. Content provider system 402 may provide remote devices (e.g., such as user device 304) access to media 320 and mixed-media datasets (e.g., via media-source metadata 318, computing device 404, and/or the like). Content provider system 402 may also provide remote management of mixed-media datasets for media assets such as, but not limited to media generation, validation of generated media, etc. Content provider system 402 may be configured to perform the operations of content provider system 302 of FIG. 3 with media generator 156 being partially or entirely operated by a remote device (e.g., computing device 404). The data controller may be operated by content provider system 302, computing device 402, and/or another device (not shown).

Computing device 404 may be a dedicated processing device designed to execute particular types of processes. For example, media generator 156 may include one or more machine-learning models for generating various types of media. Computing device 404 may include one or more graphics processing units (GPUs) to improve executing efficiency of machine-learning processes. By separating the machine-learning tasks of data controller 108 from other processing tasks of content provider system 402, content-provider system 402 may improve the rate in which read/write operations are executed (e.g., by data controller 108) without reducing operations of content-provider system 402 (e.g., such as transmitting media to user devices such as user device 304, etc.).

Content provider system 402 may receive a media generation request and transmit the request to computing device 404 (e.g., directly, through network 306, etc.). Media generator 156 of computing device 404 may generate media according to the request. If computing device 404 includes a data controller, computing device 404 may validate the generated media. If computing device 404 does not include a data controller, then computing device 404 may transmit the generated media for validation by a device with a data controller (e.g., content provider system 402, user device 304, other device, etc.). If the generated media cannot be validated, then media generator 156 may be modified (e.g., via a training iteration of the machine-learning models, adjusting weights or coefficients, generating alternative prompts, etc.) using the output from the data controller. Media generator 156 may generate a new version of the generated media for validation. The process may continue until the media generator 156 generates media that is validated by a data controller. The generated media may be transmitted to content provider system 402, the requesting device and/or user, user device 304, and/or the like.

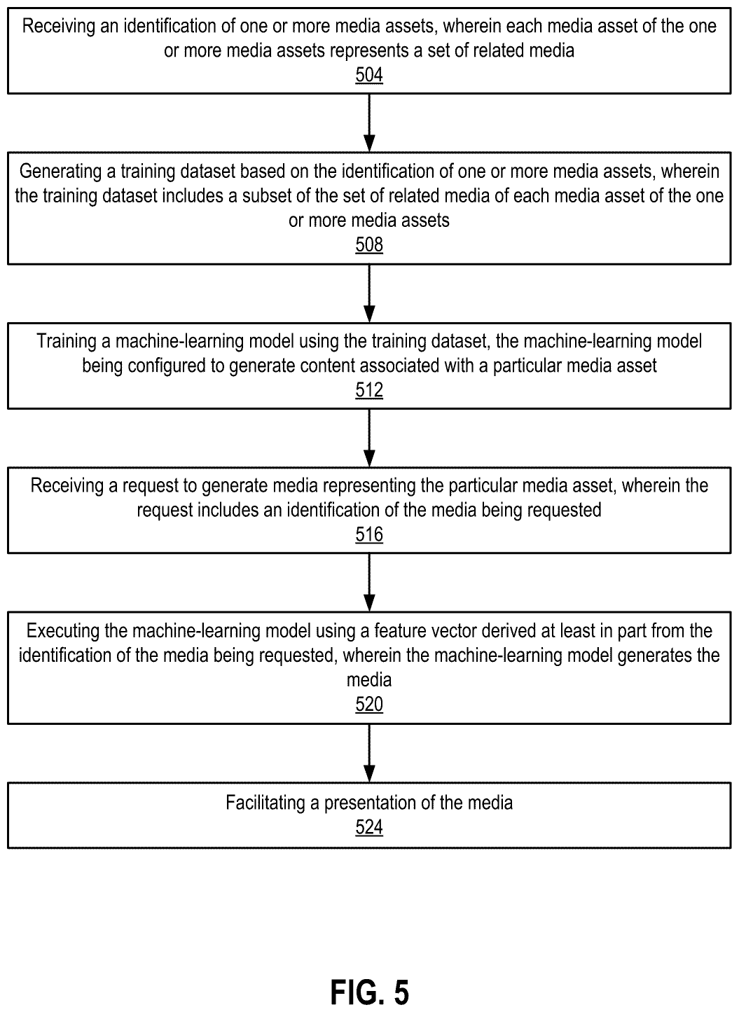

FIG. 5 illustrates a flowchart of an example process for generating media based on mixed-media datasets according to aspects of the present disclosure. At 504, a computing device (e.g., operating a media generator, etc.) may receiving an identification of one or more media assets. Each media asset of the one or more media assets may represent a set of related media. In some examples, a media asset may represent a single narrative (e.g., such as, but not limited to, a graphic novel, comic book, book, or other work), a series of narratives, a character, a subject (e.g., superheroes, etc.), a genre (e.g., fiction, non-fiction, mystery, manga, science fiction, etc.), a media type (e.g., text, images, audio segments, video segments, interactive media (e.g., video games, web-based media, etc.), webpages, combinations thereof, or the like), symbol, theme, plot detail, combinations thereof, or the like. The media asset may be used to identify a set of media that are related to the media asset. For example, a media asset that represents a character may be used to identify a set of media (e.g., related media) that includes the character or references the character in some manner.

At block 508, the computing device may generate a training dataset based on the identification of one or more media assets. The training dataset may include a subset of the set of related media of each media asset of the one or more media assets. In some instances, the training dataset may include one or more contextual details (e.g., extracted by a data controller from the set of related media, etc.) that define a canon of a media asset (e.g., a curated set of media and/or details that correspond to the media asset and define a scope of the media asset).

In some examples, the computing device may generate one or more training datasets with each training dataset being tailored for a particular machine-learning model and/or media asset of the one or more media assets. For example, the machine-learning models may be trained to generate media of a predetermined media type. The computing device may generate a training dataset tailored to the media type that a particular machine-learning model is configured to generate such that the computing device may generate a first training dataset including text (e.g., alphanumeric media, symbolic media, etc.) to train a first machine-learning model trained to generate text-based media and a second training dataset including images and/or video to train a second machine-learning model trained to generate graphical media, etc. The computing device may also generate training datasets that are limited to a particular media asset or group of media assets to improve the generation of media associated with the media asset or group of media assets. The training datasets may be tailored by selecting: the related media of the set of related media, selecting related media of the set of related media that corresponds to a particular media type, contextual details, metadata (e.g., including production information such as publication date, publication company, company information, location, data size, etc.), combinations thereof, or the like based on the particular machine-learning model being trained.

In some examples, the computing device may retrieve a predefined (or previously generated) training dataset using an identifier that corresponds to at least one of the one or more media assets. The identifier may be an identifier of a media asset, a characteristic of the media asset, a globally unique identifier, a hash, and/or the like. For example, once a training dataset is generated, the computing device may assign an identifier to the training dataset. The identifier may be usable by the computing device (and/or other devices) to identify particular training datasets for diagnostic purposes (e.g., by analyzing a training dataset used to train a particular model), training new machine-learning models, retraining or reinforcement learning, etc. Alternatively, or additionally, the computing device may dynamically derive the training dataset using the identification of the one or more media assets. For example, the computing device may use an identifier of a media asset to identify a set of media that corresponds to that media asset. The computing device may then generate the training dataset from the set of media by extracting contextual details from the set of media using one or more machine-learning models.

A training dataset may include the set of media associated with the one or more media assets, labels (e.g., for supervised learning, etc.), contextual details extracted from the set of media associated with the one or more media assets, metadata, combinations thereof, or the like. The set of media may include media corresponding to one or more media types such as, but not limited to, text, audio segments, images, video segments, interactive media (e.g., video games, web-based media, etc.), webpages, combination thereof, or the like. In some instances, the training dataset may be augmented with additional data associated with or related to the one or more media assets such as data derived from the training dataset (e.g., inferences, predictions, classifications, etc.). In some instances, such as when the training dataset is too small, the additional data may include, but is not limited to, data similar to or related to the media asset, manually generated data associated with the media asset, procedurally generated data associated with the media asset, and/or the like.

At block 512, the computing device may train a machine-learning model using the training dataset. The machine-learning model may a single model, multiple machine-learning models, an ensemble model, and/or the like configured to generate media associated with a particular media asset of the one or media assets. Examples of machine-learning models include, but are not limited to, neural networks (e.g., such as recurrent neural networks, long short-term memory (LSTM), mask recurrent neural networks, convolutional neural networks, faster convolutional neural networks, etc.), deep learning networks, you only look once (YOLO), EfficientDet, deep learning networks, transformers (generative pre-trained transformers (GPT), Bidirectional Encoder Representations from Transformers (BERTs), text-to-text-transfer-transformer (T5), etc.), generative adversarial networks (GANs), recurrent gated units (GRUs), combinations thereof, or the like. The machine-learning model may be trained using supervised learning, unsupervised learning, semi-supervised learning, transfer learning, reinforcement learning, combinations thereof, or the like. The computing device may train the machine-learning model for a predetermined time interval, predetermined quantity of iterations, and/or until the one or more accuracy metrics are reached (e.g., such as, but not limited to, accuracy, precision, area under the curve, logarithmic loss, F1 score, a longest common subsequence (LCS) such as ROUGE-L, Bilingual evaluation Understudy (BLEU) mean absolute error, mean square error, or the like).

The machine-learning model may be trained to generate media associated with a particular media asset. Examples of media that the machine-learning model is configured to generate include, but is not limited, text, images, video segments (e.g., such as, but not limited to, a trailer associated with the mixed-media dataset or media of the mixed-media dataset, a teaser for media associated with the mixed-media dataset, a movie, a looping video, a music video, an advertisement, a cutscene, such as for a video game associated with the mixed-media dataset, a dynamic typography video, a video configured for a social media platform (e.g., such as resolution, length, frame rate, etc.), an animation (e.g., such as a graphics interchange format, animated portable network graphics, etc.), combinations thereof, and/or the like), interactive media (e.g., video games, web-based media, etc.), webpages and/or documents therefor (e.g., such as, but not limited to, blog posts, encyclopedia entries, entries for an online publication, entries for crowdsourced and/or community-edited publications, instructions such as hypertext markup language or JavaScript, etc.), collateral (e.g., marketing collateral such as promotional media for the mixed-media dataset, media associated with or included in the mixed-media dataset, and/or the like), audio segments, combinations thereof, or the like.

At block 516, the computing device may receive a request to generate media representing a media asset of the one or more media assets. The request may include an identification of a particular media asset and a media type (e.g., text, image, video segment, audio segment, webpage, interactive media, combinations thereof, or the like). In some instances, the computing device may also include parameters that provide additional constraints on the media generation such as, but limited to, one or more contextual details, an indication of a quantity of media to generated (e.g., quantity of words, images, webpages, video length, etc.), data types (e.g., file types such as JPEG or PNG, encodings such as Moving Picture Experts Group (MPEG), etc.). In some examples, the request to generate media may include a prompt usable as input into the machine-learning model such as a transformer model. In other instances, a prompt may be derived from the request. For example, the request may include a selection of a media asset, a media type, etc. and generate the prompt usable as input to the machine-learning model. The prompt may be generated using the machine-learning model, another machine-learning model, user input, an algorithm, combinations thereof, or the like.

At block 520, the computing device may execute the machine-learning model using a feature vector derived at least in part from the identification of the particular media asset and the media type. The machine-learning model may generate media associated with the particular media asset and of the media type. For some media types, the output of the machine-learning model may be a specification that defines media of the media type. For instance, for webpage media, the output from the machine-learning model may be a document including hypertext markup language instructions, JavaScript instructions, cascading style sheets instructions, or the like that may define a webpage. The webpage may be hosted by the computing device and/or other host service and rendered by a browser.

The machine-learning model may be configured to generate various type of media. In some examples, the machine-learning model may be configured to generate a wiki (e.g., one or more documents that describe contextual details of portions of a media asset), advertisements for a media asset (e.g., such as text, images, video segments, combinations thereof, or the like), alternative versions of media of the media asset, new media of the media asset, new contextual details that comply with a mixed-media dataset of the media asset, combinations thereof, and/or the like.

In some examples, the computing device may process the media generated by the machine-learning model before transmitting (or presenting) the output to the requesting device. For example, the computing device may transmit the output to a data controller to validate the generated media against a portion of the training dataset that corresponds to a particular media asset (e.g., a mixed-media dataset of the media asset, etc.). The data controller may generate a feature vector from the generated media (or a feature vector for each generated media if the output includes multiple generated media) and execute a second machine-learning model using the feature vector. The data controller may validate the output by determining whether the output complies with the portion of the training dataset that corresponds to the particular media asset. For example, the data controller may determine if the output includes contextual details that conflict with the portion of the training dataset that corresponds to the particular media or deviate from the portion of the training dataset that corresponds to the particular media by more than a threshold (e.g., determined based on a distance between the output generated media and portion of the training dataset using Euclidean distance, Manhattan distance, Minkowski distance, Hamming distance, combinations thereof, or the like).

If the data controller identifies a conflict or deviation that is greater than the threshold, then the computing device may execute a reinforcement or retraining iteration of the machine-learning model. Alternatively, or additionally, the computing device may re-execute the machine-learning model using a new feature derived from the feature vector and the conflict report to generate a new media output. The new media output may be passed to the data controller for validation and the process may continue until the data controller outputs a conflict report that does not identify any conflicts or deviations greater than the threshold. The data controller may identify hallucinations, incorrectly generated media (e.g., defective media, defective contextual details, etc.), artifacts or other errors in the generated media, combinations thereof, or the like and adjust the machine-learning model to improve the generation of media (e.g., reduce a likelihood that the machine-learning model will generate media with hallucinations, incorrectly generated media, etc.).

At block 524, the computing device may facilitate a presentation of at least a portion of the media. In some instances, facilitating the presentation of at least a portion of the media may include transmitting the at least a portion of the media (or all of the media) to the requesting device. In other instances, facilitating the presentation of at least a portion of the media may include displaying the at least a portion of the media (or all of the media) via a display of the computing device, a display connected to the computing device, a display of another device such as, but not limited to, the requesting device. In still yet other instances, facilitating the presentation of at least a portion of the media may include storing the at least a portion of the media (or all of the media) for access by the requesting device and/or other devices. For example, the at least a portion of the media (or all of the media) may be stored by a hosting service that may present the at least a portion of the media (or all of the media) upon request.

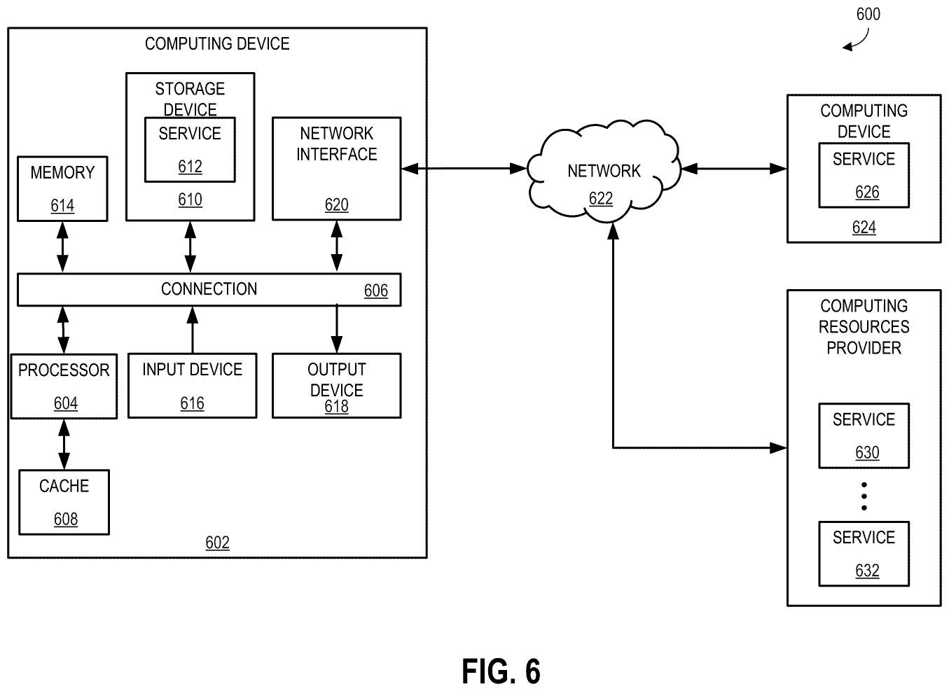

FIG. 6 illustrates a computing system architecture including various components in electrical communication with each other according to aspects of the present disclosure. The example computing system architecture 600 illustrated in FIG. 6 includes a computing device 602, which has various components in electrical communication with each other using a connection 606, such as a bus, in accordance with some implementations. The example computing system architecture 600 includes a processing unit 604 that is in electrical communication with various system components, using the connection 606, and including the system memory 614. In some embodiments, the system memory 614 includes read-only memory (ROM), random-access memory (RAM), and other such memory technologies including, but not limited to, those described herein. In some embodiments, the example computing system architecture 600 includes a cache 608 of high-speed memory connected directly with, in close proximity to, or integrated as part of the processor 604. The system architecture 600 can copy data from the memory 614 and/or the storage device 610 to the cache 608 for quick access by the processor 604. In this way, the cache 608 can provide a performance boost that decreases or eliminates processor delays in the processor 604 due to waiting for data. Using modules, methods and services such as those described herein, the processor 604 can be configured to perform various actions. In some embodiments, the cache 608 may include multiple types of cache including, for example, level one (L1) and level two (L2) cache. The memory 614 may be referred to herein as system memory or computer system memory. The memory 614 may include, at various times, elements of an operating system, one or more applications, data associated with the operating system or the one or more applications, or other such data associated with the computing device 602.

Other system memory 614 can be available for use as well. The memory 614 can include multiple different types of memory with different performance characteristics. The processor 604 can include any general-purpose processor and one or more hardware or software services, such as service 612 stored in storage device 610, configured to control the processor 604 as well as a special-purpose processor where software instructions are incorporated into the actual processor design. The processor 604 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 604 can be a microprocessor, a microcontroller, a digital signal processor (“DSP”), or a combination of these and/or other types of processors. In some embodiments, the processor 604 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 600, an input device 616 can represent any number of input mechanisms, such as a microphone for speech, a touch-sensitive screen for gesture or graphical input, keyboard, mouse, motion input, pen, and other such input devices. An output device 618 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 600. In some embodiments, the input device 616 and/or the output device 618 can be coupled to the computing device 602 using a remote connection device such as, for example, a communication interface such as the network interface 620 described herein. In such embodiments, the communication interface can govern and manage the input and output received from the attached input device 616 and/or output device 618. As may be contemplated, there is no restriction on operating on any particular hardware arrangement and accordingly the basic features here may easily be substituted for other hardware, software, or firmware arrangements as they are developed.

In some embodiments, the storage device 610 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 610 can include hardware and/or software services such as service 612 that can control or configure the processor 604 to perform one or more functions including, but not limited to, the methods, processes, functions, systems, and services described herein in various embodiments. In some embodiments, the hardware or software services can be implemented as modules. As illustrated in example computing system architecture 600, the storage device 610 can be connected to other parts of the computing device 602 using the system connection 606. In some embodiments, a hardware service or hardware module such as service 612, that performs a function can include a software component stored in a non-transitory computer-readable medium that, in connection with the necessary hardware components, such as the processor 604, connection 606, cache 608, storage device 610, memory 614, input device 616, output device 618, and so forth, can carry out the functions such as those described herein.

The disclosed systems and services (e.g., the authentication systems of FIG. 8) can be performed using a computing system such as the example computing system illustrated in FIG. 6, using one or more components of the example computing system architecture 600. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some examples, the processor can be configured to carry out some or all of methods and systems described in connection with the authentication systems described herein by, for example, executing code using a processor such as processor 604 wherein the code is stored in memory such as memory 614 as described herein. One or more of a user device, a provider server or system, a database system, or other such devices, services, or systems may include some or all of the components of the computing system such as the example computing system illustrated in FIG. 6, using one or more components of the example computing system architecture 600 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital representative (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 628. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 604 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 614 can be coupled to the processor 604 by, for example, a connector such as connector 606, or a bus. As used herein, a connector or bus such as connector 606 is a communications system that transfers data between components within the computing device 602 and may, in some embodiments, be used to transfer data between computing devices. The connector 606 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 614 can include RAM including, but not limited to, dynamic RAM (DRAM), static RAM (SRAM), synchronous dynamic RAM (SDRAM), non-volatile random-access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 614 can also include magnetic or optical data storage media including read-only (e.g., CD ROM and DVD ROM) or otherwise (e.g., CD or DVD). The memory can be local, remote, or distributed.

As described above, the connector 606 (or bus) can also couple the processor 604 to the storage device 610, which may include non-volatile memory or storage, a drive unit, and/or the like. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 610. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 606 can also couple the processor 604 to a network interface device such as the network interface 620. The interface can include one or more of a modem or other such network interfaces including, but not limited to those described herein. It will be appreciated that the network interface 620 may be considered to be part of the computing device 602 or may be separate from the computing device 602. The network interface 620 can include one or more of an analog modem, Integrated Services Digital Network (ISDN) modem, cable modem, token ring interface, satellite transmission interface, or other interfaces for coupling a computer system to other computer systems. In some embodiments, the network interface 620 can include one or more input and/or output (I/O) devices. The I/O devices can include, by way of example but not limitation, input devices such as input device 616 and/or output devices such as output device 618. For example, the network interface 620 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 602 can be connected to one or more additional computing devices such as computing device 624 via a network 622 using a connection such as the network interface 620. In such embodiments, the computing device 624 may execute one or more services 626 to perform one or more functions under the control of, or on behalf of, programs and/or services operating on computing device 602. In some embodiments, a computing device such as computing device 624 may include one or more of the types of components as described in connection with computing device 602 including, but not limited to, a processor such as processor 604, a connection such as connection 606, a cache such as cache 608, a storage device such as storage device 610, memory such as memory 614, an input device such as input device 616, and an output device such as output device 618. In such embodiments, the computing device 624 can carry out the functions such as those described herein in connection with computing device 602. In some embodiments, the computing device 602 can be connected to a plurality of computing devices such as computing device 624, each of which may also be connected to a plurality of computing devices such as computing device 624. Such an embodiment may be referred to herein as a distributed computing environment.

The network 622 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 622 can be wired connections, wireless connections, or combinations thereof. Communications via the network 622 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 622, within the computing device 602, within the computing device 624, or within the computing resources provider 628 can include information, which also may be referred to herein as content. The information may include text, graphics, audio, video, haptics, and/or any other information that can be provided to a user of the computing device such as the computing device 602. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 602 and presented to a user of the computing device 602 using forms that are perceptible via sight, sound, smell, taste, touch, or other such mechanisms. In some embodiments, communications over the network 622 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 602 and/or the computing device 624 can be connected to a computing resources provider 628 via the network 622 using a network interface such as those described herein (e.g., network interface 620). In such embodiments, one or more systems (e.g., service 630 and service 632) hosted within the computing resources provider 628 (also referred to herein as within “a computing resources provider environment”) may execute one or more services to perform one or more functions under the control of, or on behalf of, programs and/or services operating on computing device 602 and/or computing device 624. Systems such as service 630 and service 632 may include one or more computing devices such as those described herein to execute computer code to perform the one or more functions under the control of, or on behalf of, programs and/or services operating on computing device 602 and/or computing device 624.

For example, the computing resources provider 628 may provide a service, operating on service 630 to store data for the computing device 602 when, for example, the amount of data that the computing device 602 exceeds the capacity of storage device 610. In another example, the computing resources provider 628 may provide a service to first instantiate a virtual machine (VM) on service 632, use that VM to access the data stored on service 632, perform one or more operations on that data, and provide a result of those one or more operations to the computing device 602. Such operations (e.g., data storage and VM instantiation) may be referred to herein as operating “in the cloud,” “within a cloud computing environment,” or “within a hosted virtual machine environment,” and the computing resources provider 628 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 628 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, combinations thereof, or the like. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 630 and service 632 may implement versions of various services (e.g., the service 612 or the service 626) on behalf of, or under the control of, computing device 602 and/or computing device 624. Such implemented versions of various services may involve one or more virtualization techniques so that, for example, it may appear to a user of computing device 602 that the service 612 is executing on the computing device 602 when the service is executing on, for example, service 630. As may also be contemplated, the various services operating within the computing resources provider 628 environment may be distributed among various systems within the environment as well as partially distributed onto computing device 624 and/or computing device 602.

The following examples illustrate various aspects of the present disclosure. As used below, any reference to a series of examples is to be understood as a reference to each of those examples disjunctively (e.g., “Examples 1-4” is to be understood as “Examples 1, 2, 4, or 4”).

Example 1 is a method comprising: receiving an identification of one or more media assets, wherein each media asset of the one or more media assets represents a set of related media; generating a training dataset based on the identification of one or more media assets, wherein the training dataset includes a subset of the set of related media of each media asset of the one or more media assets; training a machine-learning model using the training dataset, the machine-learning model being configured to generate content associated with a particular media asset; receiving a request to generate media representing the particular media asset, wherein the request includes an identification of a media asset and a media type; executing the machine-learning model using a feature vector derived at least in part from the identification of the media asset and the media type, wherein the machine-learning model generates media associated with the media asset and of the media type; and facilitating a presentation of at least a portion of the media.

Example 2 is the method of any of example(s) 1 and 3-7, wherein the media includes one or more strings, images, or video segments representative of a characteristic of the particular media asset.

Example 3 is the method of any of example(s) 1-2 and 4-7, wherein the one or more media assets includes the particular media asset.

Example 4 is the method of any of example(s) 1-3 and 5-7, wherein the media includes one or more webpages characterizing portions of the particular media asset.

Example 5 is the method of any of example(s) 1-4 and 6-7, wherein the media includes promotional material for a related media of the set of related media of the particular media asset.

Example 6 is the method of any of example(s) 1-5 and 7, further comprising: generating metrics associated with a presentation of the media, wherein the metrics include an identification of a quantity instances in which the media is presented and an identification of one or more users that accessed the media; and facilitating presentation of a graphical user interface associated with the particular media asset, the graphical user interface including a graphical representation of the metrics and one or more controls configured to modify the generation of subsequent media associated with the particular media asset.

Example 7 is the method of any of example(s) 1-6, further comprising: generating a graphical user interface associated with the particular media asset, wherein the graphical user interface includes information associated with the particular media asset and information associated with the media; receiving a request to generate a new version of the media based on the information associated with the media; executing the machine-learning model using a new feature vector derived from an identification of the new version of the media and the information associated with the media, wherein the machine-learning model generates new media; and facilitating a presentation of the new media.

Example 8 is a system comprising: one or more processors; a non-transitory computer-readable medium storing instructions that when executed by the one or more processors, cause the one or more processors to perform operations including: receiving an identification of one or more media assets, wherein each media asset of the one or more media assets represents a set of related media; generating a training dataset based on the identification of one or more media assets, wherein the training dataset includes a subset of the set of related media of each media asset of the one or more media assets; training a machine-learning model using the training dataset, the machine-learning model being configured to generate content associated with a particular media asset; receiving a request to generate media representing the particular media asset, wherein the request includes an identification of a media asset and a media type; executing the machine-learning model using a feature vector derived at least in part from the identification of the media asset and the media type, wherein the machine-learning model generates media associated with the media asset and of the media type; and facilitating a presentation of at least a portion of the media.

Example 9 is the system of any of example(s) 8 and 10-14, wherein the media includes one or more strings, images, or video segments representative of a characteristic of the particular media asset.

Example 10 is the system of any of example(s) 8-9 and 11-14, wherein the one or more media assets includes the particular media asset.

Example 11 is the system of any of example(s) 8-10 and 12-14, wherein the media includes one or more webpages characterizing portions of the particular media asset.

Example 12 is the system of any of example(s) 8-11 and 13-14, wherein the media includes promotional material for a related media of the set of related media of the particular media asset.

Example 13 is the system of any of example(s) 8-12 and 14, wherein the operations further include: generating metrics associated with a presentation of the media, wherein the metrics include an identification of a quantity instances in which the media is presented and an identification of one or more users that accessed the media; and facilitating presentation of a graphical user interface associated with the particular media asset, the graphical user interface including a graphical representation of the metrics and one or more controls configured to modify the generation of subsequent media associated with the particular media asset.

Example 14 is the system of any of example(s) 8-13, wherein the operations further include: generating a graphical user interface associated with the particular media asset, wherein the graphical user interface includes information associated with the particular media asset and information associated with the media; receiving a request to generate a new version of the media based on the information associated with the media; executing the machine-learning model using a new feature vector derived from an identification of the new version of the media and the information associated with the media, wherein the machine-learning model generates new media; and facilitating a presentation of the new media.

Example 15 is a non-transitory computer-readable medium storing instructions that when executed by one or more processors, cause the one or more processors to perform operations including: receiving an identification of one or more media assets, wherein each media asset of the one or more media assets represents a set of related media; generating a training dataset based on the identification of one or more media assets, wherein the training dataset includes a subset of the set of related media of each media asset of the one or more media assets; training a machine-learning model using the training dataset, the machine-learning model being configured to generate content associated with a particular media asset; receiving a request to generate media representing the particular media asset, wherein the request includes an identification of a media asset and a media type; executing the machine-learning model using a feature vector derived at least in part from the identification of the media asset and the media type, wherein the machine-learning model generates media associated with the media asset and of the media type; and facilitating a presentation of at least a portion of the media.

Example 16 is the non-transitory computer-readable medium of any of example(s) 15- and 16-20, wherein the media includes one or more strings, images, or video segments representative of a characteristic of the particular media asset.

Example 17 is the non-transitory computer-readable medium of any of example(s) 15-16 and 18-20, wherein the media includes one or more webpages characterizing portions of the particular media asset.

Example 18 is the non-transitory computer-readable medium of any of example(s) 15-17 and 19-20, wherein the media includes promotional material for a related media of the set of related media of the particular media asset.

Example 19 is the non-transitory computer-readable medium of any of example(s) 15-18 and 20, wherein the operations further include: generating metrics associated with a presentation of the media, wherein the metrics include an identification of a quantity instances in which the media is presented and an identification of one or more users that accessed the media; and facilitating presentation of a graphical user interface associated with the particular media asset, the graphical user interface including a graphical representation of the metrics and one or more controls configured to modify the generation of subsequent media associated with the particular media asset.

Example 20 is the non-transitory computer-readable medium of any of example(s) 15-19, wherein the operations further include: generating a graphical user interface associated with the particular media asset, wherein the graphical user interface includes information associated with the particular media asset and information associated with the media; receiving a request to generate a new version of the media based on the information associated with the media; executing the machine-learning model using a new feature vector derived from an identification of the new version of the media and the information associated with the media, wherein the machine-learning model generates new media; and facilitating a presentation of the new media.

Client devices, computing devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a keypad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 902) include, but is not limited to, desktop computers, laptop computers, server computers, hand-held computers, tablets, smart phones, personal digital representatives, digital home representatives, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein. Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process of FIG. 5). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general-purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital representative (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 602.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112 (f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

1. A method comprising:
receiving an identification of one or more media assets, wherein each media asset of the one or more media assets represents a set of related media;
generating a training dataset based on the identification of one or more media assets, wherein the training dataset includes a subset of the set of related media of each media asset of the one or more media assets;
training a machine-learning model using the training dataset, the machine-learning model being configured to generate content associated with a particular media asset;
receiving a request to generate media representing the particular media asset, wherein the request includes an identification of a media asset and a media type;
executing the machine-learning model using a feature vector derived at least in part from the identification of the media asset and the media type, wherein the machine-learning model generates media associated with the media asset and of the media type; and
facilitating a presentation of at least a portion of the media.

2. The method of claim 1, wherein the media includes one or more strings, images, or video segments representative of a characteristic of the particular media asset.

3. The method of claim 1, wherein the one or more media assets includes the particular media asset.

4. The method of claim 1, wherein the media includes one or more webpages characterizing portions of the particular media asset.

5. The method of claim 1, wherein the media includes promotional material for a related media of the set of related media of the particular media asset.

6. The method of claim 1, further comprising:
generating metrics associated with a presentation of the media, wherein the metrics include an identification of a quantity instances in which the media is presented and an identification of one or more users that accessed the media; and
facilitating presentation of a graphical user interface associated with the particular media asset, the graphical user interface including a graphical representation of the metrics and one or more controls configured to modify the generation of subsequent media associated with the particular media asset.

7. The method of claim 1, further comprising:
generating a graphical user interface associated with the particular media asset, wherein the graphical user interface includes information associated with the particular media asset and information associated with the media;
receiving a request to generate a new version of the media based on the information associated with the media;
executing the machine-learning model using a new feature vector derived from an identification of the new version of the media and the information associated with the media, wherein the machine-learning model generates new media; and
facilitating a presentation of the new media.

8. A system comprising:
one or more processors;
a non-transitory computer-readable medium storing instructions that when executed by the one or more processors, cause the one or more processors to perform operations including:
receiving an identification of one or more media assets, wherein each media asset of the one or more media assets represents a set of related media;
generating a training dataset based on the identification of one or more media assets, wherein the training dataset includes a subset of the set of related media of each media asset of the one or more media assets;
training a machine-learning model using the training dataset, the machine-learning model being configured to generate content associated with a particular media asset;
receiving a request to generate media representing the particular media asset, wherein the request includes an identification of a media asset and a media type;
executing the machine-learning model using a feature vector derived at least in part from the identification of the media asset and the media type, wherein the machine-learning model generates media associated with the media asset and of the media type; and
facilitating a presentation of at least a portion of the media.

9. The system of claim 8, wherein the media includes one or more strings, images, or video segments representative of a characteristic of the particular media asset.

10. The system of claim 8, wherein the one or more media assets includes the particular media asset.

11. The system of claim 8, wherein the media includes one or more webpages characterizing portions of the particular media asset.

12. The system of claim 8, wherein the media includes promotional material for a related media of the set of related media of the particular media asset.

13. The system of claim 8, wherein the operations further include:
generating metrics associated with a presentation of the media, wherein the metrics include an identification of a quantity instances in which the media is presented and an identification of one or more users that accessed the media; and
facilitating presentation of a graphical user interface associated with the particular media asset, the graphical user interface including a graphical representation of the metrics and one or more controls configured to modify the generation of subsequent media associated with the particular media asset.

14. The system of claim 8, wherein the operations further include:
generating a graphical user interface associated with the particular media asset, wherein the graphical user interface includes information associated with the particular media asset and information associated with the media;
receiving a request to generate a new version of the media based on the information associated with the media;
executing the machine-learning model using a new feature vector derived from an identification of the new version of the media and the information associated with the media, wherein the machine-learning model generates new media; and
facilitating a presentation of the new media.

15. A non-transitory computer-readable medium storing instructions that when executed by one or more processors, cause the one or more processors to perform operations including:
receiving an identification of one or more media assets, wherein each media asset of the one or more media assets represents a set of related media;
generating a training dataset based on the identification of one or more media assets, wherein the training dataset includes a subset of the set of related media of each media asset of the one or more media assets;
training a machine-learning model using the training dataset, the machine-learning model being configured to generate content associated with a particular media asset;
receiving a request to generate media representing the particular media asset, wherein the request includes an identification of a media asset and a media type;
executing the machine-learning model using a feature vector derived at least in part from the identification of the media asset and the media type, wherein the machine-learning model generates media associated with the media asset and of the media type; and
facilitating a presentation of at least a portion of the media.

16. The non-transitory computer-readable medium of claim 15, wherein the media includes one or more strings, images, or video segments representative of a characteristic of the particular media asset.

17. The non-transitory computer-readable medium of claim 15, wherein the media includes one or more webpages characterizing portions of the particular media asset.

18. The non-transitory computer-readable medium of claim 15, wherein the media includes promotional material for a related media of the set of related media of the particular media asset.

19. The non-transitory computer-readable medium of claim 15, wherein the operations further include:
generating metrics associated with a presentation of the media, wherein the metrics include an identification of a quantity instances in which the media is presented and an identification of one or more users that accessed the media; and
facilitating presentation of a graphical user interface associated with the particular media asset, the graphical user interface including a graphical representation of the metrics and one or more controls configured to modify the generation of subsequent media associated with the particular media asset.

20. The non-transitory computer-readable medium of claim 15, wherein the operations further include:
generating a graphical user interface associated with the particular media asset, wherein the graphical user interface includes information associated with the particular media asset and information associated with the media;
receiving a request to generate a new version of the media based on the information associated with the media;
executing the machine-learning model using a new feature vector derived from an identification of the new version of the media and the information associated with the media, wherein the machine-learning model generates new media; and
facilitating a presentation of the new media.
